(19) United States
(12) Patent Application Publication
(10) Pub. No.: US 2024/0274009 A1
(43) Pub. Date: Aug. 15, 2024

(54) Electronic Control Device and Control Method

(71) Applicant: Hitachi Astemo, Ltd., Hitachinaka-shi, Ibaraki (JP)

(72) Inventors: Yuki HORITA, Tokyo (JP); Satoru OKUBO, Tokyo (JP)

(21) Appl. No.: 18/564,813

(22) PCT Filed: Mar. 9, 2022
(86) PCT No.: PCT/JP2022/010407

§ 371 Date: Nov. 28, 2023

(30) Foreign Application Priority Data
Jun. 2, 2021 (JP) 2021-093009

(51) Int. Cl. G08G 1/16; B60W 50/023

(52) U.S. Cl. CPC G08G 1/16; B60W 50/023

(57) ABSTRACT

An electronic control device incorporated in a vehicle includes: a sensor detection information acquiring unit that acquires detection information from a first external environment sensor and detection information from a second external environment sensor, the first external environment sensor and second external environment sensor being incorporated in the vehicle; a sensor detection information integrating unit that specifies a correspondence relationship between an environmental element indicated in detection information from the first external environment sensor and an environmental element indicated in detection information from the second external environment sensor; and a sensor detectable area determining unit that determines a relationship between a relative position and a detection capability at the first external environment sensor, based on a state of detection by the first external environment sensor of an environmental element detected by the second external environment sensor, the state of detection being indicated in the integrated detection information, and that based on the relationship, determines a detectable area for the first external environment sensor.

### TECHNICAL FIELD

The present invention relates to an electronic control device and a control method.

### BACKGROUND ART

In recent years, to realize comfortable and safe autonomous driving of a vehicle, a technique of detecting a drop in the performance of an external environment sensor of the vehicle and curbing an automatic driving function or allowing safe stoppage of the vehicle is proposed. For example, PTL 1 discloses a means by which a drop in the performance of an external environment sensor caused by its soil or failure is detected to reduce a traveling speed or cause the vehicle to stop safely. Specifically, PTL 1 carries a description “An autonomous vehicle that travels autonomously by detecting an obstacle or a traveling path with sensors includes: a sensor state evaluating means that evaluates a state of a sensor's performance dropping; a speed/steering angle limit value setting unit that sets limit values for a traveling speed and a steering angle, based on the state of the sensor's performance dropping; and an operation obstacle evaluating unit that evaluates an influence the vehicle exerts on an operation of a different vehicle when the vehicle stops at a current position. When the performance of the sensor drops, the vehicle travels at a speed and steering angle within a set speed and steering angle limit values up to a point where the vehicle does not obstruct the operation of the different vehicle and then comes to a stop.”.

### CITATION LIST

### Patent Literature

PTL 1: WO 2015/068249 A

### SUMMARY OF INVENTION

### Technical Problem

According to the invention described in PTL 1, a performance drop caused by soil sticking to a camera or a failure of the camera is detected by checking the presence or absence of a change in pixel output values from the camera, and according to a state of performance drop, the necessity of a drive mode for curbed autonomous driving or safe stoppage is determined.

Meanwhile, a drop in the performance of the external environment sensor results not only because of the soil or failure of the sensor but may also result because of a change in an external environment. For example, when a camera or light detection and ranging (LiDAR) is used as an external environment sensor, the sensor's distance performance that allows detection of a distant obstacle drops under a bad weather condition, such as heavy rain or fog. Even in a case where a millimeter wave radar, which is said to be resistant to bad weather, is used as an external environment sensor, it is known that the sensor's ability to detect a distant obstacle under heavy rain is lower than the same under normal weather. In this manner, in a case where the performance of the external environment sensor drops because of an external environmental factor, a drop in the performance of the external environment sensor cannot be detected by the method disclosed in PTL 1.

In addition, the state of the external environment continuously changes from moment to moment, and, in correspondence to this change, a degree of drop in the performance of the external environment sensor continuously changes as well. However, when a drive mode is determined by discretely determining a level of drop in the performance of the external environment sensor, as is in PTL 1, flexible traveling control corresponding to a change in the external environment is difficult. Because of this difficulty, a drive mode with a greater emphasis on safety is set, which raises a possibility that conditions under which autonomous driving can be continued may be more limited than intended conditions.

In order to solve the above problem with a conventional technique, an object of the present invention is to provide an electronic control device that can continue traveling control flexibly and safely in a case where the performance of a sensor drops because of a change in an external environment, particularly, in a case where a range in which an object can be effectively detected reduces.

### Solution to Problem

An electronic control device according to a first aspect of the present invention is incorporated in a vehicle. The electronic control device includes: a sensor detection information acquiring unit that acquires detection information from a first external environment sensor and detection information from a second external environment sensor, the first external environment sensor and second external environment sensor being incorporated in the vehicle; a sensor detection information integrating unit that specifies a correspondence relationship between an environmental element indicated in detection information from the first external environment sensor and an environmental element indicated in detection information from the second external environment sensor; and a sensor detectable area determining unit that determines a relationship between a relative position and a detection capability at the first external environment sensor, based on a state of detection by the first external environment sensor of an environmental element detected by the second external environment sensor, and that based on the relationship, determines a detectable area for the first external environment sensor.

### Advantageous Effects of Invention

According to the present invention, traveling control can be continued flexibly and safely in response to a drop in the performance of a sensor caused by a change in an external environment and to performance requirements for dealing with a road environment.

### BRIEF DESCRIPTION OF DRAWINGS

FIG. 1 is a functional block diagram of a configuration of a vehicle system including a traveling control device according to an embodiment of the present invention.

FIG. 2 is a conceptual diagram of a detectable area for an external environment sensor group 4 incorporated in a vehicle 2.

FIG. 3 depicts an example of a sensor detection information data group 31.

FIG. 4 depicts an example of an integrated detection information data group 34.

FIG. 5 depicts an example of a sensor detectable area data group 35 according to a first embodiment.

FIG. 6 depicts a correlation between functions implemented by the traveling control device according to the embodiment.

FIG. 7 is a flowchart for explaining a process executed by a sensor detectable area determining unit 13 according to the first embodiment.

FIG. 8 depicts an example of a method of calculating a sensor detectable area, the method being executed at S712 of FIG. 7.

FIG. 9 depicts an example of traveling environment detection performance requirement information used by a traveling control mode determination unit 14.

FIG. 10 is a flowchart for explaining a process executed by the traveling control mode determination unit 14.

FIG. 11 depicts an example of a sensor detectable area data group 35 according to a second embodiment.

FIG. 12 is a flowchart for explaining a process executed by the sensor detectable area determining unit 13 according to the second embodiment.

### DESCRIPTION OF EMBODIMENTS

### First Embodiment

### —First Embodiment—

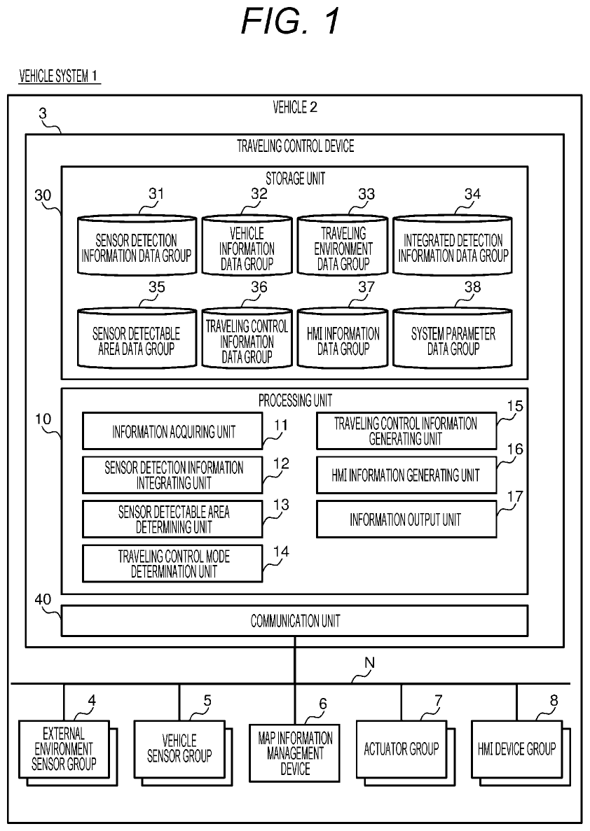

Hereinafter, a first embodiment of a traveling control device 3 that is an electronic control device will be described with reference to FIGS. 1 to 10.

### (System Configuration)

FIG. 1 is a functional block diagram of a configuration of a vehicle system 1 including the traveling control device 3 according to an embodiment of the present invention. The vehicle system 1 is incorporated in a vehicle 2. The vehicle system 1 recognizes a situation around the vehicle 2, such as a road to travel and an obstacle like a vehicle nearby, and performs proper drive assistance and traveling control. As shown in FIG. 1, the vehicle system 1 includes the traveling control device 3, an external environment sensor group 4, a vehicle sensor group 5, a map information management device 6, an actuator group 7, and a human machine interface (HMI) device group 8. The traveling control device 3, the external environment sensor group 4, the vehicle sensor group 5, the map information management device 6, the actuator group 7, and the HMI device group 8 are interconnected via an in-vehicle network N. Hereinafter, to distinguish the vehicle 2 from a different vehicle, the vehicle 2 may be referred to as a “host vehicle” 2.

The traveling control device 3 is an electronic control unit (ECU). The traveling control device 3 generates traveling control information for assistance in driving the vehicle 2 or autonomous driving of the vehicle 2, based on various input information from the external environment sensor group 4, the vehicle sensor group 5, and the like, and outputs the traveling control information to the actuator group 7 and the like. The traveling control device 3 includes a processing unit 10, a storage unit 30, and a communication unit 40. The processing unit 10 includes, for example, a central processing unit (CPU). The processing unit 10, however, may further include a graphics processing unit (GPU), a field-programmable gate array (FPGA), and an application specific integrated circuit (ASIC), in addition to the CPU, or may be composed of one of these units.

The processing unit 10 includes an information acquiring unit 11, a sensor detection information integrating unit 12, a sensor detectable area determining unit 13, a traveling control mode determination unit 14, a traveling control information generating unit 15, an HMI information generating unit 16, and an information output unit 17, which are functions of the processing unit 10. The processing unit 10 implements these functions by executing given operation programs stored in the storage unit 30.

The information acquiring unit 11 acquires various types of information from a different device connected to the traveling control device 3 via the in-vehicle network N, and stores the acquired information in the storage unit 30. For example, the information acquiring unit 11 acquires information on an observation point around the vehicle 2, the observation point being detected by the external environment sensor group 4, and information on an environmental element present around the vehicle 2, such as an obstacle, a road marking, a sign, and a signal, the environmental element being estimated based on information on the observation point, and stores the acquired information in the storage unit 30, as a sensor detection information data group 31 representing detection information from the external environment sensor group 4. The information acquiring unit 11 acquires also information about a movement, state, and the like of the vehicle 2 detected by the vehicle sensor group 5, and stores the acquired information in the storage unit 30, as a vehicle information data group 32. The information acquiring unit 11 acquires also information about a traveling environment and a traveling path of the vehicle 2, from the map information management device 6 and the like, and stores the acquired information in the storage unit 30, as a traveling environment data group 33.

The sensor detection information integrating unit 12 generates integrated detection information on environmental elements present around the vehicle 2, such as obstacles, road markings, signs, and signals, based on the sensor detection information data group 31 acquired by the information acquiring unit 11 and stored in the storage unit 30. A process executed by the sensor detection information integrating unit 12 is equivalent to, for example, a function generally referred to as sensor fusion. Integrated detection information generated by the sensor detection information integrating unit 12 is stored in the storage unit 30, as an integrated detection information data group 34.

The sensor detectable area determining unit 13 determines a sensor detectable area indicating a detectable area for the external environment sensor group 4, based on the sensor detection information data group 31 acquired by the information acquiring unit 11 and stored in the storage unit 30. For example, the sensor detectable area determining unit 13 determines a detectable area where a single sensor included in the external environment sensor group 4 is capable of detection or a detectable area where a combination of multiple sensors of the same type are capable of detection, to be a sensor detectable area. Hereinafter, a combination of external environment sensors (which include a single external environment sensor) for which a sensor detectable area is determined will be referred to as a “sensor group”. The sensor detectable area determining unit 13 determines a sensor detectable area for each sensor group, and stores information on each sensor detectable area determined in the storage unit 30, as the sensor detectable area data group 35.

The sensor detectable area refers to an area where when an environmental element, such as an obstacle, a road marking, a sign, or a signal is present in the area, the sensor group can detect the environmental element with a sufficiently high probability. In other words, the sensor detectable area is an area where the probability of the sensor group's failing to detect the environmental element is sufficiently low, and therefore when the sensor group does not detect the environmental element to be detected, such as the obstacle, in this area, it can be concluded that the environmental element to be detected is not present in this area. In many cases, product specifications of each sensor making up the external environment sensor group 4 define a sensor detectable area in a static manner. Actually, however, the sensor detectable area changes depending on an external environment. The sensor detectable area determining unit 13 dynamically estimates a sensor detectable area for each sensor group, from information on a state of detection, detection accuracy, a detection position, and the like of each sensor group that are indicated in integrated detection information generated by the sensor detection information integrating unit 12.

The traveling control mode determination unit 14 determines a traveling control mode of the vehicle system 1 in which mode the vehicle 2 can travels safely, based on a system state (failure state, occupant's instruction mode, etc.) of the vehicle system 1 and the traveling control device 3, performance requirements for the external environment sensor group 4 to meet for detection in a traveling environment, the state of a sensor detectable area determined by the sensor detectable area determining unit 13, and the like. Information on the traveling control mode determined by the traveling control mode determination unit 14 is stored in the storage unit 30, as a part of a system parameter data group 38.

The traveling control information generating unit 15 generates traveling control information on the vehicle 2, based on a sensor detectable area generated by the sensor detectable area determining unit 13, integrated detection information generated by the sensor detection information integrating unit 12, a traveling control mode determined by the traveling control mode determination unit 14, and the like. For example, the traveling control information generating unit 15 plans a track on which the vehicle 2 should travel, based on these pieces of information, and determines a control instruction value to be outputted to the actuator group 7 for causing the vehicle 2 to follow the planned track. The traveling control information generating unit 15 then generates traveling control information, using the determined planned track and control instruction value and a result of determination of the traveling control mode by the traveling control mode determination unit 14. Traveling control information generated by the traveling control information generating unit 15 is stored in the storage unit 30, as a traveling control information data group 36.

The HMI information generating unit 16 generates HMI information on the vehicle 2, based on a sensor detectable area generated by the sensor detectable area determining unit 13, integrated detection information generated by the sensor detection information integrating unit 12, a traveling control mode determined by the traveling control mode determination unit 14, and the like. For example, the HMI information generating unit 16 generates information for informing an occupant of the current state of a traveling control mode and a change in the traveling control mode by voice, an image, or the like. The HMI information generating unit 16 generates also information for informing the occupant of the sensor detectable area and the integrated detection information on the vehicle 2 by an image or the like. These pieces of information, i.e., HMI information generated by the HMI information generating unit 16 are stored in the storage unit 30, as an HMI information data group 37.

The information output unit 17 outputs traveling control information generated by the traveling control information generating unit 15 to a different device connected to the traveling control device 3, via the in-vehicle network N. For example, the traveling control device 3 outputs traveling control information including a control instruction value determined by the traveling control information generating unit 15 to the actuator group 7, thus controlling traveling of the vehicle 2. In addition, the traveling control device 3 outputs traveling control information including a traveling control mode determined by the traveling control mode determination unit 14 to the different device so that the vehicle system 1 can shift to a system mode that is consistent as a whole.

The storage unit 30 includes, for example, a storage device, such as a hard disk drive (HDD), a flash memory, and a read only memory (ROM), and a memory, such as a random access memory (RAM). The storage unit 30 stores programs to be processed by the processing unit 10, data groups necessary for such processing, and the like. The storage unit 30 serves also as a main memory that when the processing unit 10 executes a program, temporarily store data necessary for computations involved in the program. In this embodiment, as information for implementing the functions of the traveling control device 3, the sensor detection information data group 31, the vehicle information data group 32, the traveling environment data group 33, the integrated detection information data group 34, the sensor detectable area data group 35, the traveling control information data group 36, the HMI information data group 37, the system parameter data group 38, and the like are stored in the storage unit 30.

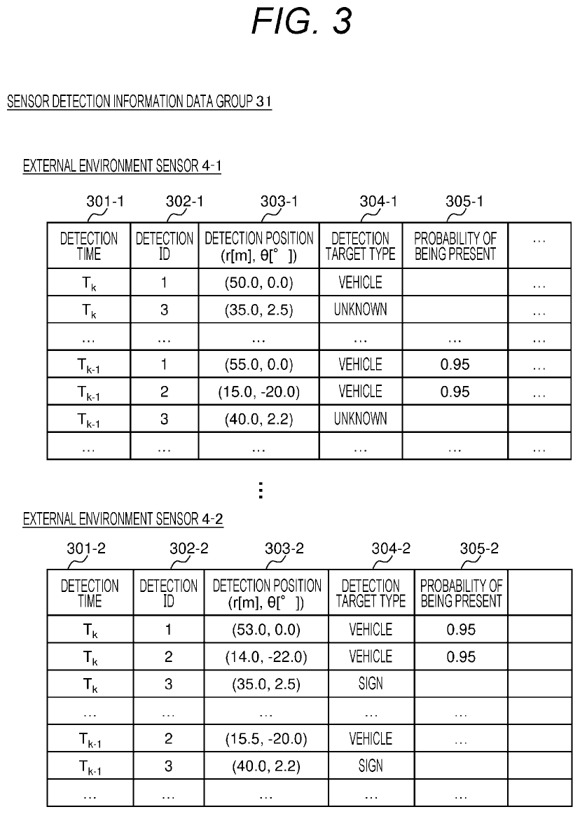

The sensor detection information data group 31 is a set of data on detection information acquired by the external environment sensor group 4 and on the reliability of the detection information. Detection information refers to, for example, information on environmental elements, such as obstacles, road markings, signs, and signals, that the external environment sensor group 4 specifies based on its sensing observation information, or to the observation information itself acquired by the external environment sensor group 4 (point cloud information from a LiDAR, FFT information from a millimeter wave radar, images taken by cameras, parallax images from a stereo camera, and the like). The reliability of detection information is equivalent to a degree of certainty of information on an environmental element detected by a sensor, that is, observation information being actually present (probability of being present), and varies depending on the type or specifications of the sensor. For example, in the case of a sensor, such as a LiDAR or a millimeter wave radar, that makes observations using reflected waves, the reliability may be expressed in the form of the reception intensity or signal-to-noise ratio (SN ratio) of the sensor or may be calculated according to the number of times of consecutive observations made along the time series. Any index indicative of a degree of certainty of detection information may be considered to be the reliability of detection information. An example of expression of sensor detection information data in the sensor detection information data group 31 will be described later with reference to FIG. 3. The sensor detection information data group 31 is acquired from the external environment sensor group 4 by the information acquiring unit 11 and is stored in the storage unit 30.

The vehicle information data group 32 is a set of data on the movement, state, and the like of the vehicle 2. The vehicle information data group 32 includes information on, for example, the position, traveling speed, steering angle, accelerator operation amount, a brake operation amount, and the like of the vehicle 2, which are vehicle information detected by the vehicle sensor group 5 and the like and acquired by the information acquiring unit 11.

The traveling environment data group 33 is a set of data on a traveling environment of the vehicle 2. Data on the traveling environment is information on roads around the vehicle 2, the roads including a road on which the vehicle 2 is traveling. This information includes information on, for example, a traveling path of the vehicle 2, a road on the traveling path or around the vehicle 2, and the shape or attributes (traveling direction, speed limit, traveling regulations, etc.) of a lane making up the road.

The integrated detection information data group 34 is a set of integrated detection information data on environmental elements present around the vehicle 2, the data being determined based on detection information from the external environment sensor group 4. The integrated detection information data group 34 is generated and stored by the sensor detection information integrating unit 12, based on information on the sensor detection information data group 31.

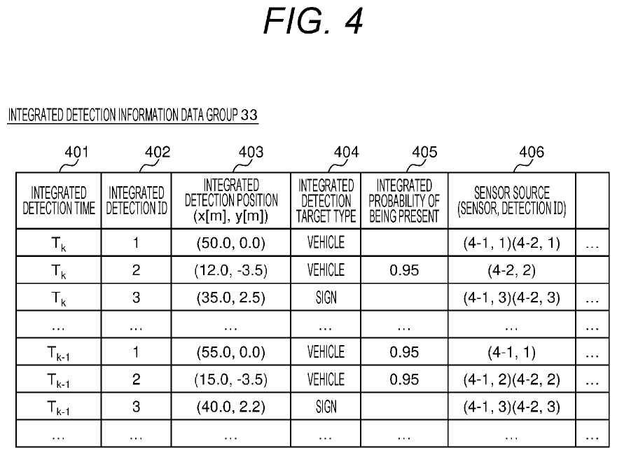

The sensor detectable area data group 35 is a set of data on a sensor detectable area, which is an area where each sensor group in the external environment sensor group 4 can detect an environmental element, such as an obstacle. An example of expression of data on a sensor detectable area in the sensor detectable area data group 35 will be described later with reference to FIG. 4. The sensor detectable area data group 35 is generated and stored by the sensor detectable area determining unit 13, based on information on the sensor detection information data group 31 and information on the integrated detection information data group 34.

The traveling control information data group 36 is a group of data on plan information for controlling traveling of the vehicle 2, and includes a planned track of the vehicle 2 and a control instruction value outputted to the actuator group 7. These pieces of information included in the traveling control information data group 36 are generated and stored by the traveling control information generating unit 15.

The HMI information data group 37 is a group of data on HMI information for controlling the HMI device group 8 incorporated in the vehicle 2, and includes information for informing the occupant of the state of a traveling control mode and a change thereof, the state of sensors in the vehicle 2, an environmental element detection situation, and the like, via the HMI device group 8. These pieces of information included in the HMI information data group 37 are generated and stored by the HMI information generating unit 16.

The system parameter data group 38 is a set of data on detection performance requirements to be met for a system state of the vehicle system 1 and the traveling control device 3 (traveling control mode, failure state, occupant's instruction mode, etc.) and a traveling environment.

The communication unit 40 has a communication function of communicating with a different device connected via the in-vehicle network N. The communication function of the communication unit 40 is used when the information acquiring unit 11 acquires various types of information from the different device via the in-vehicle network N or when the information output unit 17 outputs various types of information to the different device via the in-vehicle network N. The communication unit 40 includes, for example, a network card or the like conforming to such a communication protocol as IEEE 802.3 or a controller area network (CAN). In the vehicle system 1, the communication unit 40 carries out data exchange between the traveling control device 3 and the different device in accordance with various protocols.

In this embodiment, the communication unit 40 and the processing unit 10 are described as different units separated from each other. However, some of processes by the communication unit 40 may be executed in the processing unit 10. For example, such a configuration may be adopted that a hardware device responsible for a communication process is located in the communication n unit 40 as other device driver groups, communication protocol processing, and the like are located in the processing unit 10.

The external environment sensor group 4 is a group of devices that detect the state of surroundings of the vehicle 2. The external environment sensor group 4 is, for example, a group of various sensors, such as a camera device, a millimeter wave radar, a LiDAR, and a sonar. The external environment sensor group 4 outputs its sensing observation information and information on environmental elements, such as obstacles, road markings, signs, and signals, specified based on the observation information, to the traveling control device 3 via the in-vehicle network N. “Obstacles” include, for example, a different vehicle different from the vehicle 2, a pedestrian, a falling object on a road, and a road edge. “Road marking” include, for example, a white line, a crosswalk, and a stop line.

The vehicle sensor group 5 is a group of devices that detect various states of the vehicle 2. Each vehicle sensor detects, for example, information on a position, a traveling speed, a steering angle, an accelerator operation amount, a brake operation amount, and the like of the vehicle 2, and outputs the detected information to the traveling control device 3 via the in-vehicle network N.

The map information management device 6 is a device that manages and provides digital map information on the surroundings of the vehicle 2 and information on a traveling path of the vehicle 2. The map information management device 6 is composed of, for example, a navigation device or the like. The map information management device 6 has, for example, digital road map data of a given area including the surroundings of the vehicle 2, and specifies the current position of the vehicle 2 on the map, that is, a road or lane on which the vehicle 2 is traveling, based on position information or the like on the vehicle 2 that is outputted from the vehicle sensor group 5. The map information management device 6 outputs the specified current position of the vehicle 2 and map data on the surroundings of the vehicle 2 to the traveling control device 3 via the in-vehicle network N.

The actuator group 7 is a device group that controls control elements, such as a steering wheel, a brake, and an accelerator, that determine the movement of the vehicle. The actuator group 7 controls the movement of the vehicle, based on information on the driver's operation of the steering wheel, the brake pedal, the accelerator pedal, and the like and on a control instruction value outputted from the traveling control device 3.

The HMI device group 8 is a group of devices each having a human machine interface (HMI) that allows the occupant to exchange information with for the vehicle system 1. HMIs include, for example, an audio interface, such as a microphone or a speaker, and a screen interface, such as a display or a panel. The HMI device group 8 equipped with these HMIs outputs information to the vehicle system 1, based on an instruction from the occupant coming in through the HMI, and provides the occupant with information, based on HMI information outputted from the traveling control device 3 and the like.

### (Sensor Detectable Area)

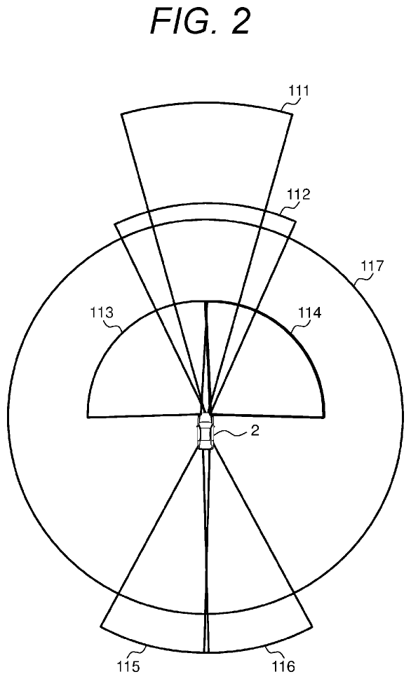

FIG. 2 is a conceptual diagram of a detectable area for an external environment sensor group 4 incorporated in the vehicle 2. Although an example for explaining the sensor detectable area is shown in FIG. 2, the external environment sensor group 4 is actually installed in such a way as to meet detection performance requirements from the autonomous drive function of the vehicle system 1.

In the example of FIG. 2, seven sensors (external environment sensors 4-1 to 4-7) are installed in the vehicle 2, and rough sensor detectable areas for these sensors are indicated as areas 111 to 117, respectively. For example, the external environment sensor 4-1 corresponding to the area 111 is a long-range millimeter wave radar, the external environment sensor 4-2 corresponding to the area 112 is a camera-type sensor, the external environment sensors 4-3 to 4-6 corresponding to the areas 113 to 116 are short-range millimeter wave radars, and the external environment sensor 4-7 corresponding to the area 117 is a LiDAR. In FIG. 2, for simpler description, the sensor detectable areas 111 to 117 are expressed as fan shapes with their centers on the vehicle 2. In practice, however, each sensor detectable area can be expressed as any given shape according to the detection range of each sensor. It should be noted that the size and shape of the sensor detectable area changes according to the external environment.

The traveling control device 3 compares detection results in overlapping areas of detection ranges of a plurality of external environment sensors, and determines respective effective detection ranges of the external environment sensors. For example, in FIG. 2, the area 111 for the long distance millimeter wave radar and the area 112 for the camera-type sensor overlap each other. Because the outer edge in a distance direction of the area 112 for the camera-type sensor is included in the area 111 for the long distance millimeter wave radar, a drop in the performance of the camera-type sensor in the distance direction can be identified by comparing a detection results of the camera-type sensor with a detection result of the long distance millimeter wave radar. Similarly, because the outer edge in an angular direction of the area 111 for the long distance millimeter wave radar is included in the area 112 for the camera-type sensor, a drop in the performance of the long distance millimeter wave radar in the angular direction can be identified by comparing detection results of the long distance millimeter wave radar with a detection result of the camera-type sensor.

### (Sensor Detection Information)

FIG. 3 depicts an example of sensor detection information stored in the sensor detection information data group 31. This FIG. 3 shows an example of a data structure of sensor detection information acquired by the above external environment sensor 4-1 (long-range millimeter wave radar) and an example of a data structure of sensor detection information acquired by the above external environment sensor 4-2 (camera-type sensor).

The sensor detection information data acquired by the external environment sensor 4-1 and the same acquired by the external environment sensor 4-2 each include detection time 301, detection ID 302, detection position 303, detection target type 304, and probability of being present 305.

The detection time 301 is information on a point of time of detection of detection information of the entry. This information may be time information, or in a case of the external environment sensor being a sensor that makes detection cyclically, may be a number indicating in which cycle the detection information of the entry is detected.

The detection ID 302 is an ID for identifying each detection information entry. This may be set such that the same ID is assigned to the same detection target object along the time series or that IDs are assigned as serial numbers in each cycle.

The detection position 303 is information on a position at which an environmental element corresponding to the detection information entry is present. In FIG. 3, the detection position is expressed as polar coordinates defined by a distance r and an angle θ in a reference coordinate system for the sensor. The detection position, however, may be expressed as coordinates defined in an orthogonal coordinates system.

The detection target type 304 represents the type of the environmental element indicated by the detection information entry. As the detection type, for example, vehicle, pedestrian, white line, sign, signal, road edge, and unknown are each entered.

The probability of being present 305 is information indicating g at what probability the environmental element corresponding to the detection information of the entry is actually present. For example, in the case of a millimeter wave radar or LiDAR, a drop in its SN ratio leads to difficulty in distinguishing noise from a reflected wave from an environmental element as a detection target object, thus resulting in a higher possibility of erroneous detection. During its process of specifying an environmental element, each sensor of the external environment sensor group 4 calculates and sets the probability of being present (or an index equivalent thereto), based on the SN ratio or a state of detection along the time series.

### (Integrated Detection Information)

FIG. 4 depicts an example of an integrated detection information stored in the integrated detection information data group 34. This FIG. 4 shows an example of a data structure that results from integration of the sensor detection information acquired by the external environment sensor 4-1 and the sensor detection information acquired by the external environment sensor 4-2 that are shown in FIG. 3.

The integrated detection information data includes integrated detection time 401, integrated detection ID 402, integrated detection position 403, integrated detection target type 404, integrated probability of being present 405, and sensor source 406.

The integrated detection time 401 is information indicating a state of detection at which point of time the integrated detection information of the entry represents. In many cases, the detection time 301 of the sensor detection information varies, depending on the type of an external environment sensor. In addition, the detection time 301 actually indicates a past point of time to the true detection time because of a time lag between the point of detection by the external environment sensor and the point of acquisition of detection data by the traveling control device 3. To reduce the influence of such a time variation and time lag, it is preferable that the sensor detection information integrating unit 12 correct a given time to provide integrated information, based on the detection time 301 of the sensor detection information and on own vehicle information, such as a speed and an angular velocity, included in the vehicle information data group 32. The integrated detection time 401 is thus set as a corrected detection time.

The integrated detection ID 402 is an ID for identifying each integrated detection information entry. The integrated detection ID 402 is set such that the same ID is assigned to the same detection target object (environmental element) along the time series.

The integrated detection position 403 is information on the position of an environmental element indicated by the integrated detection information of the entry. In FIG. 4, the integrated detection position is expressed as x-y coordinates on a vehicle coordinate system (coordinate system in which the center of a rear axle is defined as the origin, the front side of the vehicle is defined as a positive x direction, and the left side of the vehicle is defined as a positive y direction), but may be expressed as coordinates on a different coordinate system.

The integrated detection target type 404 indicates the type of the environmental element indicated by the integrated detection information of the entry. As the detection type, for example, vehicle, pedestrian, white line, sign, signal, road edge, and unknown are each entered.

The integrated probability of being present 405 is information indicating at what probability the integrated environmental element corresponding to the integrated detection information of the entry is actually present.

The sensor source 406 is information indicating based on which sensor detection information the integrated detection information of the entry has been generated. The sensor source 406 is configured such that a sensor detection information entry used for estimating the integrated detection information of the entry can be specified by checking the sensor detection information data group 31 against information indicated by the sensor source 406. The sensor source 406 is expressed as, for example, a combination of a sensor identifier and a detection ID. The detection time 301 may be added to this combination when a time series data entry needs to be specified.

### (Sensor Detectable Area Data Group)

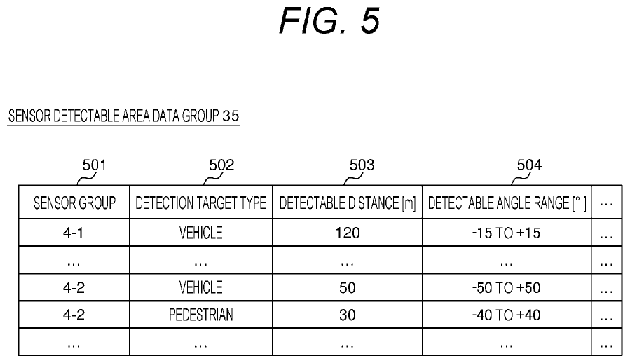

FIG. 5 depicts an example of a structure of some data stored in the sensor detectable area data group 35. The sensor detectable area data group 35 is generated in units of sensor groups making up the external environment sensor group 4. This FIG. 5 shows an example of a structure of pieces of data each generated for a given sensor group.

The sensor detectable area data includes sensor group 501, detection target detectable distance 503, and detectable angle range 504.

The sensor group 501 is an identifier for a sensor group for which a sensor detectable area information of the entry is made.

The detection target type 502 is information indicating which environmental element type is specified as a detection target in the sensor detectable area information of the entry. As the detection type, for example, vehicle, pedestrian, white line, sign, signal, road edge, and unknown are each entered.

The detectable distance 503 and the detectable angle range 504 represent a distance and an angle range, respectively, at which the sensor group 501 of the entry is assumed to be capable of detecting a detection target, i.e., the detection target type 502. For example, a sensor group “4-2” shown in FIG. 5 can detect a vehicle up to 50 m ahead of the host vehicle and can detect a pedestrian up to 30 m ahead of the host vehicle.

In FIG. 5, a sensor detectable area is expressed in the form of a combination of a detectable distance and a detectable angle range, but may be expressed in other forms. For example, the sensor detectable area may be expressed in such a way that the detectable angle range of the sensor is divided into given units of divided ranges and a detectable distance in each divided range is expressed as the sensor detectable area. The external environment sensor may show a performance difference, depending on detection angles. For example, the camera-type sensor shows lower performance at a boundary of an angle of view. When such a performance difference needs to be taken into consideration, it is preferable that a detectable distance set in accordance with a detection angle be expressed.

### (System Operation)

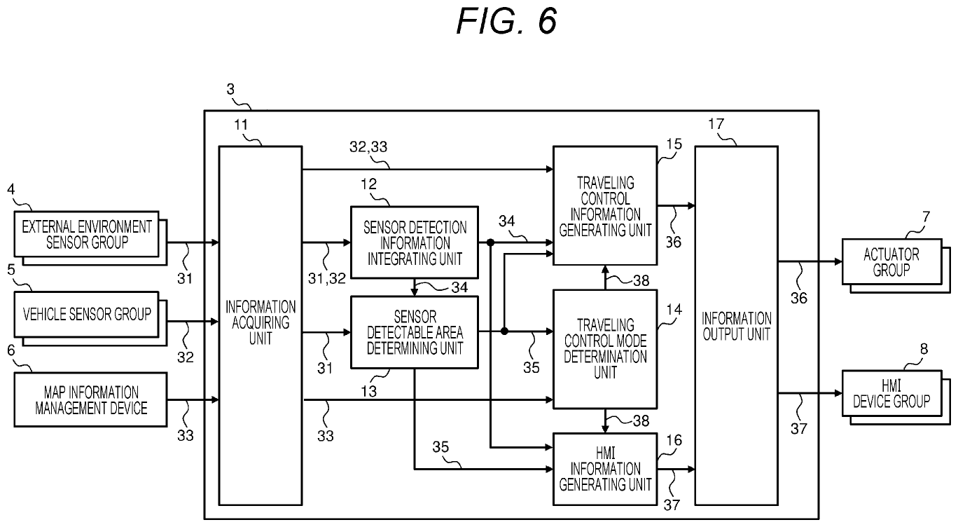

The operation of the vehicle system 1 will be described with reference to FIGS. 6 to 10.

FIG. 6 depicts a correlation between functions implemented by the traveling control device 3.

The information acquiring unit 11 acquires necessary information from a different device via the in-vehicle network N and delivers the acquired information to a processing unit in a subsequent stage. Specifically, the information acquiring unit 11 acquires the sensor detection information data group 31, the vehicle information data group 32, and the traveling environment data group 33, respectively, from the external environment sensor group 4, the vehicle sensor group 5, and the map information management device 6, and delivers the acquired data groups to the processing unit in the subsequent stage. Delivery of each data group may be carried out via, for example, the storage unit 30 (not illustrated).

Based on the sensor detection information data group 31 and the vehicle information data group 32 acquired from the information acquiring unit 11, the sensor detection information integrating unit 12 generates the integrated detection information data group 34, in which detection information from a plurality of external environment sensors is integrated, and stores the integrated detection information data group 34 in the storage unit 30. The generated integrated detection information data group 34 is then outputted to the sensor detectable area determining unit 13 and to the traveling control information generating unit 15.

The sensor detectable area determining unit 13 determines a detectable area for each sensor group of the external environment sensor group 4, based on the sensor detection information data group 31 acquired from the information acquiring unit 11 and the integrated detection information data group acquired from the sensor detection information integrating unit 12, and stores the determined detectable area in the storage unit 30, as the sensor detectable area data group 35, and then delivers the detectable area to a processing unit in a subsequent stage.

The traveling control mode determination unit 14 determines a traveling control mode of the vehicle 2, based on the traveling environment data group 33 acquired from the information acquiring unit 11, on the sensor detectable area data group 35 acquired from the sensor detectable area determining unit 13, on a system state (failure state, the occupant's instruction mode, etc.) of the vehicle system 1 and the traveling control device 3, the system state being stored in the system parameter data group 38, and on detection performance requirements to be met for a traveling environment. The traveling control mode determination unit 14 then stores a result of the determination in the storage unit 30, as a part of the system parameter data group 38, and outputs the result of the determination to the traveling control information generating unit 15. Information on the system parameter data group 38 can be generated by an external device to the traveling control device 3 or by each processing unit. This fact is, however, not depicted in FIG. 6.

The traveling control information generating unit 15 determines a traveling control mode of the vehicle 2, based on the integrated detection information data group 34 acquired from the sensor detection information integrating unit 12, on the sensor detectable area data group 35 acquired from the sensor detectable area determining unit 13, on the vehicle information data group 32 and the traveling environment data group 33 acquired from the information acquiring unit 11, and on a result of determination of a traveling control mode of the vehicle 2, the result of determination being included in the system parameter data group 38 and acquired from the traveling control mode determination unit 14, and plans a track for traveling control and generates a control instruction value or the like for causing the vehicle to follow the track. The traveling control information generating unit 15 then generates the traveling control information data group 36 including the above information, stores the traveling control information data group 36 in the storage unit 30, and outputs the traveling control information data group 36 to the information output unit 17.

The HMI information generating unit 16 generates the HMI information data group 37 for informing the occupant of integrated detection information, a sensor detectable area, the state of a traveling control mode, and a change in the state, based on the integrated detection information data group 34 acquired from the sensor detection information integrating unit 12, on the sensor detectable area data group 35 acquired from the sensor detectable area determining unit 13, and on a result of determination of a travel control mode of the vehicle 2, the result of determination being included in the system parameter data group 38 and acquired from the traveling control mode determination unit 14, and stores the HMI information data group 37 in the storage unit 30 and outputs the HMI information data group 37 to the information output unit 17.

The information output unit 17 outputs traveling control information on the vehicle 2, based on the traveling control information data group 36 acquired from the traveling control information generating unit 15 and on the HMI information data group 27 acquired from the HMI information generating unit 16. For example, the information output unit 17 outputs traveling control information including a control instruction value to the actuator group 7 or outputs traveling control information including a current traveling control mode to a different device.

### (Sensor Detection Information Integrating Process)

Based on the sensor detection information data group 31 and the vehicle information data group 32 acquired from the information acquiring unit 11, the sensor detection information integrating unit 12 generates the integrated detection information data group 34, in which detection information from a plurality of external environment sensors is integrated, and stores the integrated detection information data group 34 in the storage unit 30.

A sensor detection information integrating process is equivalent to a sensor fusion process on detection information. The sensor detection information integrating unit 12 first compares pieces of detection information from individual external environment sensors, the pieces of detection information being included in the sensor detection information data group 31, to identify detection information on the same environmental element. The sensor detection information integrating unit 12 then integrates pieces of identified sensor detection information to generate the integrated detection information data group 34.

For example, in FIG. 3, an entry in which detection ID 302-1 of the external environment sensor 4-1 is “1” and an entry in which detection ID 302-2 of the external environment sensor 4-2 is “1” have detection positions close to each other and the same detection target type “vehicle”. For this reason, the sensor detection information integrating unit 12 determines that these two entries represent detection of the same environmental element, thus integrating information on the two entries to generate integrated detection information. The generated integrated detection information corresponds to an entry in which integrated detection ID 402 is “1” shown in FIG. 4. When generating integrated detection information, the sensor detection information integrating unit 12 records the sensor source 406 that indicates which information on which detection IDs from which sensors is integrated. For example, sensor source 406 “(4-1, 1) (4-2, 1)” in an entry in which integrated detection ID 402 is “1” shown in FIG. 4 indicates that the information of the entry is created by integrating together information in which detection ID of the external environment sensor 4-1 is “1” and information in which detection ID of the external environment sensor 4-2 is “1” that are shown in FIG. 3.

### (Sensor Detectable Area Determining Process)

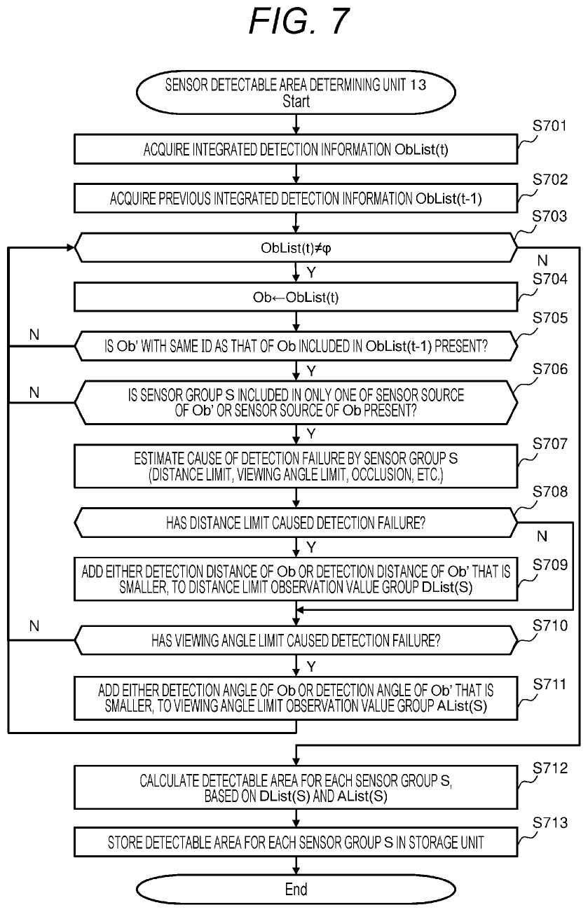

FIG. 7 is a flowchart for explaining a process executed by the sensor detectable area determining unit 13 of FIG. 6, according to the first embodiment. In the first embodiment, a limit point (performance limit point) of a detection capability of each sensor group is extracted by comparing time series data included in integrated detection information, and a sensor detectable area for each sensor group is determined based on information on the extracted limit point of the detection capability. The sensor detectable area determining unit 13 executes processes of S701 to S713 to generate sensor detectable area data on each sensor group, and stores the sensor detectable area data in the storage unit 30, as the sensor detectable area data group 35.

First, at S701 and S702, integrated detection information ObList (t) generated at a given point of time and integrated detection information ObList (t-1) generated in a process cycle one cycle before generation of the integrated detection information ObList (t) are acquired from the integrated detection information data group 34 stored in the storage unit 30. It is preferable that the integrated detection information generated at the given point of time be the latest integrated detection information at the point of time of execution of the present process. It should be noted that the sensor detection information data group 31 and the integrated detection information data group 34 include data related to detection information and integrated detection information processed in the previous process, in addition to the latest detection information from the external environment sensor group 4 that is acquired by the information acquiring unit 11 and the latest integrated detection information generated by the sensor detection information integrating unit 12.

Subsequently, processes of S703 to S711 are executed on each entry included in ObList (t). In the processes of S703 to S711, by searching time series data of the integrated detection information for a position at which a sensor group's state of detection of the same environmental element changes, a performance limit point of the sensor group is extracted. The sensor group's state of detection refers to, for example, whether the sensor group is being able to or unable to detect the environmental element as the detection target. In such a case, a change in state of detection in time series data is either a change from a state of being able to detect to a state of being unable to detect or a change from a state of being unable to detect to a state of being able to detect. Both cases mean that there is a high possibility that the sensor group has crossed its performance limit point before and after its state of detection changes.

At S703, whether an unprocessed entry is present in ObList (t) is checked. When no unprocessed entry is present (N at S703), the process flow proceeds to S712. When an unprocessed entry is present (Y at S703), the process flow proceeds to S704, at which one entry Ob is extracted.

Then, at S705, whether an entry Ob′ with the same integrated detection ID 402 as the integrated detection ID 402 of the entry Ob is present in ObList (t-1) is checked. When the entry Ob′ is not present (N at S705), the process flow returns to S703. When the entry Ob′ is present (Y at S705), the process flow proceeds to S 706.

At S706, sensor source 406 of the entry Ob and that of the entry Ob ‘are compared to check whether a sensor group S included in only one of both entries is present. When such sensor group S is not present (N at S 706), the process flow returns to S703. When the sensor group S is present (Y at S 706), the process flow proceeds to S707. A sensor group indicated in only one of the sensor sources 406 of the entries Ob and Ob’ implies that during time passage from the entry Ob′ to the entry Ob, the sensor group has become incapable of detecting an environmental element that was detectable to the sensor group or has become capable of detecting an environmental element that was undetectable to the sensor group. In other words, it may possibly indicate a boundary part of a performance limit of the sensor group.

What should be heeded in this case is that the entries Ob and Ob′ are detected not just by the sensor group showing its boundary part of the performance limit but also by a different sensor group. In the case of an environmental element detected only by the sensor group showing its the boundary part of the performance limit, if the sensor group becomes incapable of detecting the environmental element, the environmental element is no longer included in the integrated detection information because sensor detection information itself is no longer present in such a case. This means that a change in a given sensor group's state of detection is checked based on a detection result from a different sensor group.

A change in a given sensor group's state of detection may be determined from time series data of sensor detection information acquired by the sensor group, the time series data being included in the sensor detection information data group 31. In such a case, a position at which the presence or absence of an entry for the same environmental element changes in the time series data of the sensor detection information is extracted. However, the case of extracting the performance limit value, based on a change in a single sensor group's state of detection, may involve lots of cases of an environmental element being erroneously detected or cases of the environmental element shielded by a different obstacle being undetectable, and therefore leads to a greater error in estimating the performance limit. The case of extracting the performance limit value, based on a change in a state of detection of an environmental element detected by a different sensor group, on the other hand, reduces a possibility of an erroneous detection or a possibility of an environmental element shielded by a different obstacle, and therefore offers an effect of reducing an error in estimating the performance limit.

At S707, a cause (cause of detection failure) by which the sensor group S was not able to detect the environmental element in either Ob or Ob′ is estimated. For example, a performance limit in detection distance (distance limit) being exceeded, a performance limit in detection angle (viewing angle limit) being exceed, shielding (occlusion) by a different obstacle, and the like are conceivable causes of detection failure. When an environmental element detected by a different sensor group is the detection target, the possibility of occlusion is low. However, in the case of a millimeter-wave radar, for example, even if the environmental element is shielded by a front-running vehicle, the millimeter-wave radar may be able to detect the environmental element (a different vehicle ahead of the front-running vehicle) through a gap under the front-running vehicle. A camera, on the other hand, is not able to detect the different vehicle ahead of the front-running vehicle when the different vehicle is shielded by the front-running vehicle. Hence a situation can arise where the different vehicle ahead of the front-running vehicle can be detected by the millimeter-wave radar but cannot be detected by the camera because the camera's view is completely blocked by the front-running vehicle. To eliminate such a case, causes of detection failure including occlusion are estimated.

Whether the cause of detection failure is occlusion is determined from, for example, a positional relationship between integrated detection position 403 of an integrated detection information entry (Ob or Ob′) in which the sensor group S has failed in detection and integrated detection position 403 of another integrated detection information entry, both entries being included in the same integrated detection information (ObList (t) or ObList (t-1)) generated at a given timing. When each integrated detection position 403 is transformed into the polar coordinate system viewed from the sensor group S, a detection distance r and a detection angle θ in the sensor group S are obtained. When the detection distance and the detection angle of the integrated detection information entry in which the sensor group S has failed in detection are r0 and θ0, respectively, if another integrated detection information entry that satisfies θ0−Δθ≤θ<θ0+Δθ and r0>r is present, it means that in a view from the sensor group S, another environmental element is present closer to the host vehicle than an undetected environmental element. When it can be determined from features (size, height, etc.) of the environmental element present closer to the host vehicle that a possibility of the undetected environmental element being shielded is high, the cause of detection failure is determined to be occlusion.

Whether the cause of detection failure is a viewing angle limit is determined, for example, in a case where integrated detection position 403 of the integrated detection information entry, at which integrated detection position 403 the sensor group S has failed in detection, is in a range near the boundary of a viewing angle of the sensor group S and occlusion is not the cause of detection failure.

Whether the cause of detection failure is a distance limit is determined, for example, in a case where the cause of detection failure is neither occlusion nor viewing angle limit.

When a result of determination of the cause of detection failure at S707 is a distance limit (Y at S708), either a detection distance of Ob or a detection distance of Ob′ that is smaller is added, together with a detection time of the detection distance, to a distance limit observation value group DList (S), as an observation value for the distance limit concerning the sensor group S (S709). In this example, the detection distance that is smaller is defined as the observation value for the distance limit. However, an average of the detection distances of Ob and Ob′ or the detection distance that is larger may be defined as the observation value for the distance limit.

When the result of determination of the cause of detection failure at S707 is not a distance limit (N at S708), the process flow proceeds to S710, at which whether the cause of detection failure is determined to be a viewing angle limit is checked. When the cause of detection failure is determined to be a viewing angle limit (Y at S710), either a detection angle of Ob or a detection angle of Ob′ that is smaller in absolute value is added, together with a detection time of the detection angle, to a viewing angle limit observation value AList (S), as an observation value for the viewing angle limit concerning the sensor group S (S711). In this example, the detection angle that is smaller in absolute value is defined as the observation value for the viewing angle limit. However, an average of the detection angles of Ob and Ob′ or the detection angle that is larger in absolute value may be defined as the observation value for the viewing angle limit.

The distance limit observation value group DList (S) and the viewing angle limit observation value group AList (S) hold information added thereto in the past. In other words, DList (S) and AList (S) store time series data of observation values related to the distance limit and the viewing angle limit of the sensor group S. In practice, however, it is preferable that consumption of a memory capacity be suppressed by deleting data entries stored for a period longer than a given period or putting such data entries in a ring buffer to keep the number of stored entries equal to or smaller than a given value.

When the cause of detection failure is not determined to be a viewing angle limit at S707 (N at S710), the process flow returns to S703.

When processes of S703 to S711 on all the entries of ObList (t) are completed, the process flow proceeds to S712. At S712, for each sensor group, a sensor detectable area at the present point of time is calculated based on the distance limit observation value group DList (S) and the viewing angle limit observation value group AList (S). Then, the calculated detectable area for each sensor group is stored in the storage unit 30, as the sensor detectable area data group 35 (S713), at which the process flow comes to an end.

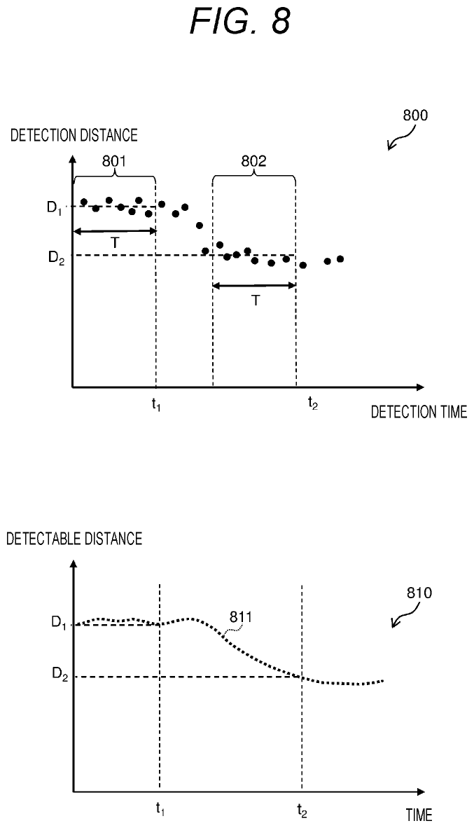

FIG. 8 depicts an example of a method of calculating a sensor detectable distance, based on DList (S), the method being executed at S712. A graph 800 of FIG. 8 is an example of a graph in which a distance limit observation value group included in DList (S) of a given sensor group S is plotted with the horizontal axis representing detection time and the vertical axis representing distance limit observation value. This example demonstrates that a tendency of detection distances of the sensor group S changes as time goes by and that a distribution of the detection distances in a time zone near time t₂ is lower than a distribution of the detection distances in a time zone near time t₁. This means that a drop in the performance of the sensor group S occurs due to an external environmental factor, such as bad weather. For example, under a bad weather condition, such as heavy rain or dense fog, the camera-type sensor's field of view gets weaker as it reaches a farther distant point, in which situation noise comes into parallax information for calculating a distance based on a plurality of images or into an outline of an object in recognition processing. As a result, the detection distance tends to decrease, compared with the detection distance in a normal situation. The LiDAR too is affected by raindrops, water vapor, and the like, undergoing a rise in the attenuation rate of reflected waves, thus showing the same results as the camera-type sensor shows.

The detectable distance of the sensor group S is obtained from, for example, statistical values, such as an average, a maximum, and a minimum of distance limit observation values taken in T seconds counted backward from a calculation point of time. For example, at time t₁ and time t₂ of the graph 800, an observation value group 801 and an observation value group 802 are used to calculate the detectable distance, respectively. In the graph 800, averages of these observation value groups are calculated as detectable distances, which are denoted as D1 and D2, respectively. A graph 810 of FIG. 8 is a graph in which the calculated detectable distance is defined as the vertical axis while calculation time is defined as the horizontal axis.

The method of calculating the detectable distance, based on the distance limit observation value group DList (S), has been described. Similarly, the detectable angle can also be calculated, based on the viewing angle limit observation value group AList (S).

### (Traveling Control Mode Determination Process)

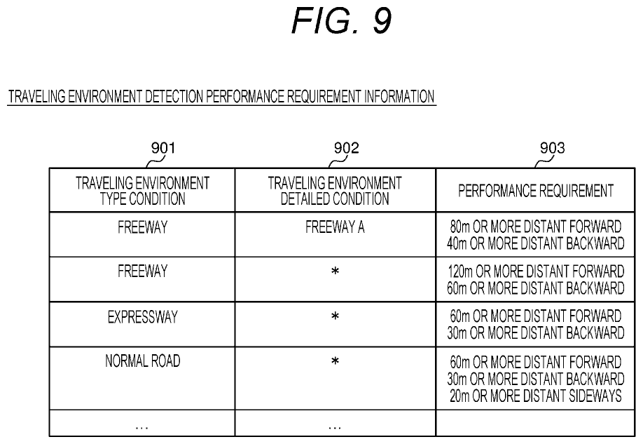

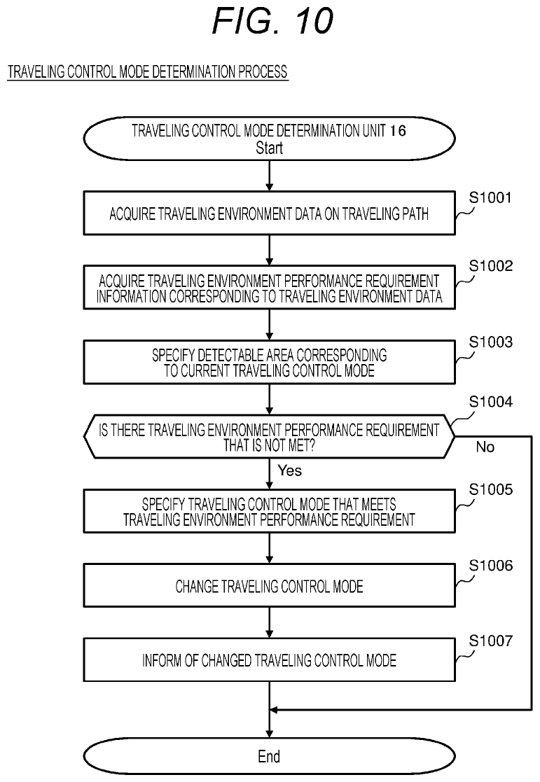

A process by the traveling control mode determination unit 14 will be described with reference to FIGS. 9 and 10. The traveling control mode determination unit 14 determines a traveling control mode of the vehicle system 1, based on the traveling environment data group 33 and the sensor detectable area data group 35 and on the system parameter data group 38 including a system state (failure state, the occupant's instruction mode, etc.) of the vehicle system 1 and the traveling control device 3. In addition to causing the vehicle system 1 to shift to a proper system state in accordance with a failure state of the vehicle system 1 and an autonomous drive instruction from the occupant, the traveling control mode determination unit 14 determines a traveling control mode, based on a detection performance request to a sensor in a traveling environment and on the actual limit performance of the sensor indicated in a sensor detectable area.

FIG. 9 depicts an example of traveling environment detection performance requirement information that is information indicating detection performance requirements to a sensor in the traveling environment. The traveling environment detection performance requirement information is a type of system parameter that determines behavior of the vehicle system 1, and is assumed to be stored in the system parameter data group 38.

Traveling environment type condition 901 represents a road type condition applied to an entry, and is specified as a freeway, an expressway (other than freeways), a general road, and the like.

Traveling environment condition details 902 represent detailed conditions regarding the traveling environment, the detailed conditions being applied to the entry, and are expressed as, for example, a specific road name, road attributes (the number of lanes, a maximum curvature, the presence/absence of road construction work, etc.), and the like. In FIG. 9, “freeway A” is shown as an example of detailed conditions given as a specific road name. “*” is a wildcard, which means that any given condition is applied.

Performance requirement 903 represents detection performance the external environment sensor group 4 is required to exert under a traveling environment condition expressed as a combination of the traveling environment type condition 901 and the traveling environment detailed condition 902. For example, in FIG. 9, the performance requirement 903 is expressed as a combination of a detection direction (frontward, backward, sidewise) and a detection distance relative to the vehicle 2. It should be noted that the shape of a specific area required for each of frontward, rearward, and sidewise detection directions is properly defined according to the detection distance.

FIG. 10 is a flowchart for explaining a traveling control mode determination process. The traveling control mode determination unit 14 executes processes of S1001 to S1007, determines a traveling control mode of the vehicle system 1, and changes the traveling control mode and informs of the change when necessary.

At S1001, the traveling control mode determination unit 14 acquires traveling environment data on a traveling path, from the traveling environment data group 13. Then, at S1002, the traveling control mode determination unit 14 specifies a corresponding performance requirement from the driving environment performance requirement information shown in FIG. 9, referring to road information included in driving environment data. For example, when the vehicle is traveling on a freeway different from the freeway A, the performance requirement is “120 m or more distant forward and 60 m or more distant backward”.

Subsequently, at S1003, the traveling control mode determination unit 14 specifies a detectable area corresponding to a current traveling control mode, referring to the sensor detectable area data group 35. The traveling control mode is defined, for example, in accordance with an autonomous drive level. SAE J3016 specifies that the driver is responsible for driving in a mode of autonomous drive level 2 or lower, while the system is responsible for driving in a mode of autonomous drive level 3 or higher. Therefore, when the vehicle runs in a traveling control mode of autonomous drive level 3 or higher, a redundant system configuration is set in principle to deal with a failure or malfunction of sensors or actuators. Because the performance requirement needs to be met with system redundancy, an area that can be detected by a plurality of sensors is specified with reference to the sensor detectable area data group 35. In a mode of autonomous drive level 2 or lower, on the other hand, system redundancy is unnecessary and therefore an area that can be detected by a single sensor is specified with reference to the sensor detectable area data group 35.

Subsequently, at S1004, the traveling control mode determination unit 14 compares the performance requirement acquired at S1002 with the detectable area specified at S1003, and determines whether the performance requirement is met. In the example of FIG. 9, the performance requirement is expressed as a detectable distance in a detection direction with respect to the vehicle 2. With assumption that the detection direction is properly defined, the performance requirement can be converted into information on “area”. The performance requirement, therefore, can be compared with the detectable area. It should be noted that the detectable area may be expressed in the form of a detectable distance in each detection direction in conformity with the expression of the traveling environment detection performance requirement information.

When a result of the comparison indicates that an area indicated by the performance requirement is within a surrounding detectable area, it means that the performance requirement is met, in which case the process flow ends without changing the traveling control mode (No at S1004). When the area indicated by the performance requirement is not within the surrounding detectable area, it means that the performance requirement is not met, in which case the process flow proceeds to S1005 (Yes at S1004).

At S10005, the traveling control mode determination unit 14 specifies a traveling control mode that meets the traveling environment performance requirement. It is assumed in this case that three traveling control modes, i.e., manual driving mode, autonomous drive level 2 mode, and autonomous drive level 3 mode are present and that the autonomous drive level 3 mode is currently selected. When it is determined at S904 that the performance requirement for the autonomous drive level 3 mode is not met, then, whether the performance requirement for the autonomous drive level 2 mode is met is determined. When the performance requirement is met, the autonomous drive level 2 mode is selected. If the performance requirement for even the autonomous drive level 2 mode is not met, the manual drive mode is selected. The above description has been made by explaining autonomous drive levels as mode examples. Modes may be subdivided by defining autonomous drive function levels. For example, the autonomous drive level 2 mode may be subdivided into a mode in which lane changing is automatically determined, a mode in which lane changing is not allowed unless a manual instruction is given, a mode in which only following the current lane is permitted, and the like. For example, in the case of only following the current lane, a performance requirement for sidewise detection is unnecessary. In this case, therefore, it is possible that aside from a detection performance requirement for the traveling environment, a detection performance requirement is defined for each traveling control mode and that a proper traveling control mode is determined, based on whether detection performance requirements for both the traveling environment and the traveling control mode are met. In such a case, the detection performance requirement for the traveling environment defines a minimum requirement that makes traveling control under a road environment (traveling environment) effective, and the detection performance requirement for the traveling control mode defines a stricter condition.

When a traveling control mode is selected at S1005, a traveling control mode changing process is executed at S1006. The traveling control mode is finally determined through inter-device adjustment for ensuring the consistency of the vehicle system 1 as a whole, interaction with the driver for transferring control to the driver on a necessary basis, and the like. Then, the determined traveling control mode is imparted to related functions and peripheral devices at S1007, at which the present process comes to an end.

### (Traveling Control Information Generating Process)

The traveling control information generating unit 15 plans traveling control over the vehicle 2 so that the vehicle 2 can travel safely and comfortably toward a destination indicated by a traveling path specified by the traveling environment data group 33. A basic process flow is to generate a traveling track along which the vehicle 2 travels safe and comfortably while avoiding an obstacle detected by the external environment sensor group 4 by following traffic rules indicated by the traveling environment data group 33 and the integrated detection information data group 34 and to generate a control instruction value for following the traveling track. According to the present invention, traveling safety and comfortability is improved by utilizing the sensor detectable area data group 35 as well.

The performance limit of the external environment sensor group 4 varies, depending on the external environment. Under a bad weather condition, the detectable distance of the external environment sensor gets shorter and consequently the surrounding detectable area of the same gets narrower, too. At a position beyond the surrounding detectable area, it is possible that the absence of detection information is in fact the result of external environment group 4 failing to detect an obstacle. If the traveling track is generated in the same manner as in a normal situation without being conscious of a fact that the detection performance of the external environment sensor has dropped due to bad weather or the like, it poses the risk of inviting various accidents, such as a collision with an obstacle and poor ride comfort caused by sharp deceleration.

To avoid such a case, the traveling control information generating unit 15 generates, for example, a track on which the vehicle 2 travels at such a speed that allows the vehicle 2 to stop safely within the surrounding detectable area. When an allowable deceleration rate of the vehicle 2 is α and the current speed of the vehicle 2 is v, a distance the vehicle 2 travels from its start of deceleration to stoppage is v²/2α. When a distance from the current position of the vehicle 2 to a point intersecting with an area of high potential risk on the traveling path is L, it is necessary to control the speed of the vehicle 2 in such a way as to at least satisfy L>v²/2α. Under this traveling control, however, sharp deceleration is executed at a point of time at which the above requirement L>v²/2 is no longer met. It is therefore preferable that, actually, gradual deceleration be executed before the point of time at which the above requirement is no longer met. For example, a method is adopted, by which a time TTB (time to braking) to take to reach the point of time at which the vehicle 2 no longer meets above requirement is introduced as an index and the speed of the vehicle 2 is adjusted based on the time TTB. TTB is given as (L-v²/2α)/v. To avoid sharp deceleration, for example, gradual deceleration (<α) may be executed when TTB becomes equal to or less than a given value or the speed may be controlled so that TTB becomes equal to or larger than a given value.

The traveling control information generating unit 15 generates traveling control information on the vehicle 2, based on a traveling control mode of the vehicle system 1 that is determined by the traveling control mode determination unit 14 and on a control instruction value determined by the above planned traveling control. Hence traveling control information can be generated, based on detection information from each sensor of the external environment sensor group 4 and on a sensor detectable area determined by the sensor detectable area determining unit 13. Traveling control for which sensors' detection performance is sufficiently taken into consideration, therefore, can be carried out.

### (HMI Information Generating Process)

The HMI information generating unit 16 reports and presents information on traveling control over the vehicle 2 via the HMI device group 8, and generates information for reducing the uneasiness and discomfort of the occupant of the vehicle 2 about traveling control.

The HMI information generating unit 16 generates information for informing the occupant of the state of a traveling control mode determined by the traveling control mode determination unit 14 and a change in the state, by voice, images, or the like. It is preferable, in particular, that a change in the traveling control mode be presented to the occupant, together with reasons for the change. For example, when the detection capability of the sensor drops due to bad weather or the like and therefore an autonomous drive level needs to be lowered, a voice message “Sensor's detection capability dropped. Switch to manual driving.” is issued or the same message is put on the screen. The HMI information generating unit 16 generates information necessary for such HMI control (information on a change in the traveling control mode and reasons for the change) according to a preset format.

The HMI information generating unit 16 generates also information for presenting a detection situation around the vehicle system 1 to the occupant, based on a sensor detectable area generated by the sensor detectable area determining unit 13 and on integrated detection information generated by the sensor detection information integrating unit 12. For example, displaying the current sensor detectable areas as shown in FIG. 2, together with the integrated detection information, on the screen allows the occupant to know up to what range the vehicle system 1 covers as sensor detectable range and what object the vehicle system 1 is actually detecting. As a result, as described above, when the vehicle travels at lower speed because of a drop in the sensor's detection capability under a bad weather condition, the occupant can understand the reasons for traveling at lower speed. The occupant's feeling of something wrong with traveling control, therefor, can be reduced.

According to the above embodiment, the performance limit of the sensor, which changes depending on the external environment, can be quantified and therefore a traveling control mode can be set flexibly according to the performance limit. For example, by quantitatively comparing a performance requirement for a traveling control mode in the traveling environment with a performance limit at the point of time of setting the traveling control mode, a traveling control mode allowing the vehicle system 1 to ensure its functions can be selected properly. When the performance limit of the sensor is not quantified, whether the performance requirement is met cannot be determined properly, in which case there is no option but determining a traveling control mode with stronger emphasis placed on safety. In such a case, autonomous driving is stopped even in a situation where continuing autonomous driving is supposed to be allowed. This leads to less usefulness of the autonomous drive function. In contrast, the present invention allows the autonomous drive function to run continuously up to its limit while ensuring safety, and therefore offers an effect of improving the usefulness of the autonomous drive function.

According to the above embodiment, because the performance limit of the sensor that changes depending on the external environment can be quantified, a safe traveling control plan according to the performance limit can be set. Being controlled in such a way as to travel at a speed that allows stopping safely in an area where the external environment sensor group 4 can detect an obstacle with high reliability, the vehicle is able to travel at a safe speed in a situation where visibility is poor due to bad weather or the like. When the performance limit of the sensor is not quantified, a safe traveling speed cannot be determined, which leaves no option but traveling at a safety-oriented lower speed. As a result, the vehicle travels in an excessively decelerated condition, which poses a problem that the occupant's ride comfort gets poorer. In contrast, the present invention allows the vehicle to travel continuously with its deceleration kept at a proper level while ensuring safety, thus offering an effect of improving the ride comfort.

The above described one embodiment of the present invention offers the following effects.

The traveling control device 3 disclosed in the first embodiment is an electronic control device incorporated in the vehicle 2. The traveling control device 3 includes: the information acquiring unit 11 serving as a sensor detection information acquiring unit, the information acquiring unit 11 acquiring detection information from a first external environment sensor and detection information from a second external environment sensor, the first external environment sensor and second external environment sensor being incorporated in the vehicle; the sensor detection information integrating unit 12 that specifies a correspondence relationship between an environmental element indicated in detection information from the first external environment sensor and an environmental element indicated in detection information from the second external environment sensor; and the sensor detectable area determining unit 13 that determines a relationship between a relative position and a detection capability at the first external environment sensor, based on the a state of detection by the first external environment sensor of an environmental element detected by the second external environment sensor, and that based on the relationship, determines a detectable area for the first external environment sensor.

The traveling control device 3 can detect a drop in the performance of the first external environment sensor caused by a change in the external environment, follow an actual change in the detectable area, and contribute to continuation of flexible and safe traveling control.

For example, the second external environment sensor is incorporated in the vehicle, the sensor detection information integrating unit generates integrated detection information indicating the environmental elements which are detected by the first external environment sensor and the second external environment sensor and for which the correspondence relationship is specified, and the sensor detectable area determining unit determines a detectable area for the first external environment sensor, based on a change in a state of detection by the first external environment sensor of an environmental element indicated by the integrated detection information.

In such a configuration, the performance of the first external environment sensor can be evaluated, using output from a sensor fusion system.

In the first embodiment, a case where an in-vehicle sensor different from the first external environment sensor is used as the second external environment sensor has been exemplarily described. The second external environment sensor, however, may be an infra-sensor set on the road. By acquiring information on environmental elements from a different vehicle, the different vehicle may be used as the second external environment sensor.

In the first embodiment, the sensor detectable area determining unit determines a relationship between a relative position and a detection capability at the first external environment sensor, based on a detection position at which a state of detection by the first external environment sensor of an environmental element detected by the second external environment sensor has changed, the detection position being indicated in time series data of the integrated detection information.

Because of this, a change in the detection capability of the first external environment sensor can be accurately reflected.

In the first embodiment, the sensor detectable area determining unit also estimates a cause by which a state of detection by the first external environment sensor of an environmental element detected by the second external environment sensor has changed, and based on the estimated cause, determines a relationship between a relative position and a detection capability at the first external environment sensor.

Specifically, the relationship between the relative position and the detection capability is expressed as a combination of a detectable distance and a detectable angle range. The sensor detectable area determining unit thus determines whether the cause of change in the state of detection is a cause related to a detection distance or a cause related to a detection angle, determines a detectable distance for the first external environment sensor, based on the determined cause related to the detection distance, and determines a detectable angle range for the first external environment sensor, based on the determined cause related to the detection angle.

Furthermore, the sensor detectable area determining unit determines whether the cause of change in the state of detection is occlusion by a different obstacle, and does not use information indicating the determined cause being occlusion by the different obstacle, as information for determining the relationship between the relative position and the detection capability at the first external environment sensor.

In this manner, by obtaining the detection distance and the detection angle, based on the cause of change in the state of detection by the first external environment sensor, the detection capability of the first external environment sensor can be accurately evaluated.

Furthermore, the sensor detectable area determining unit can determine the detection reliability of the first external environment sensor by comparing detection position information from the first external environment sensor about detection of the environmental element with detection position information from the second external environment sensor about detection of the environmental element, and can determine a state of detection by the first external environment sensor, based on the detection reliability.

The first embodiment further includes the traveling control information generating unit 15 serving as a vehicle control information generating unit, the traveling control information generating unit 15 generating control information on the vehicle, based on a detectable area for the first external environment sensor that is determined by the sensor detectable area determining unit and on the integrated detection information.

In this manner, the reliability of the first external environment sensor as well as the detection range for the same are evaluated, which contributes to safe traveling control.

### Second Embodiment

### —Second Embodiment—

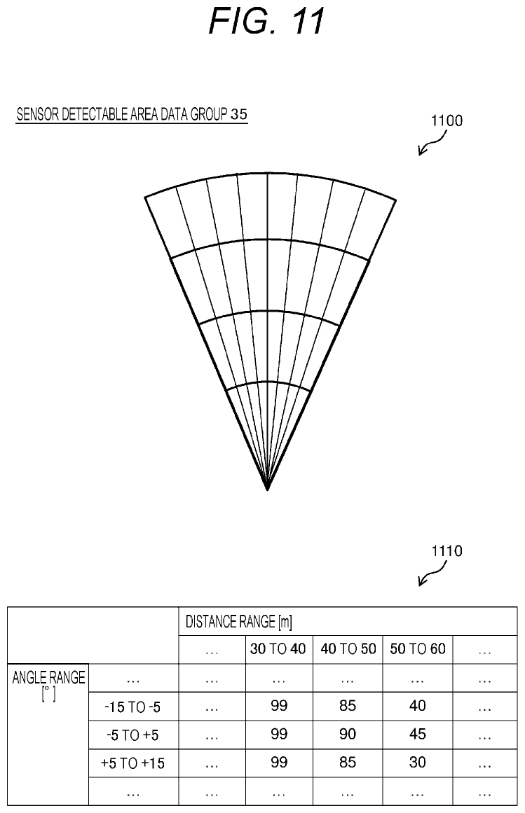

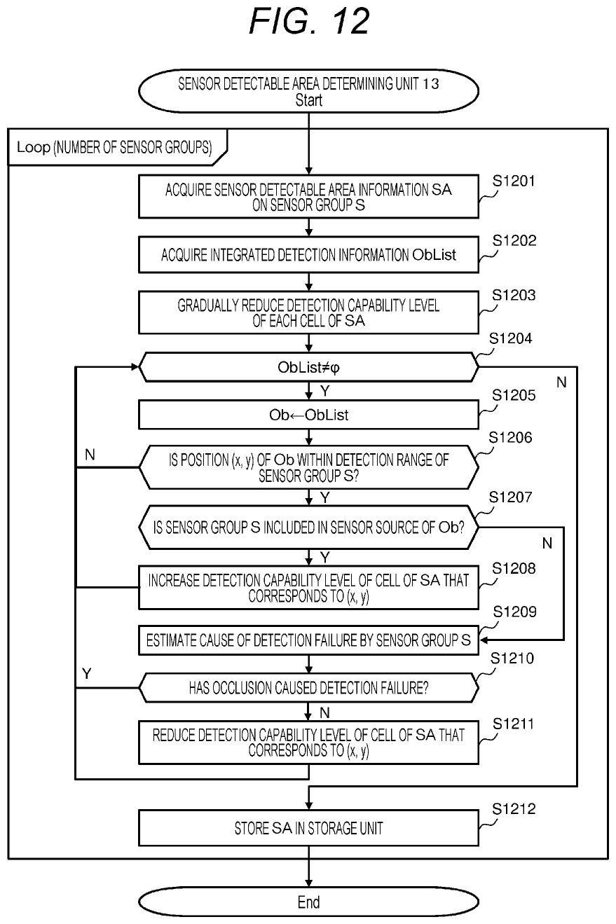

A second embodiment of the electronic control device will be described with reference to FIGS. 11 and 12. In the following description, the same constituent elements as described in the first embodiment will be denoted by the same reference signs, and differences will be mainly described. Some respects not described specifically are the same constituent elements as described in the first embodiment.

In the first embodiment, the sensor detectable area data group 35 is expressed as a combination of a detectable distance and a detectable angle range, as shown in FIG. 5. This is a method suitably applied to a case where a sensor configuration is simple and its detection range can be approximated by a fan shape or a case where obtaining a detailed detectable area is unnecessary, e.g., a case of a freeway or an expressway. In a case where complicated control is required, e.g., a case of an ordinary road, however, it is necessary that which relative position on the road surface is visible to what extent be understood. To meet this requirement, in the second embodiment, the sensor detectable area data group 35 is expressed as a grid-like map.

FIG. 11 depicts an example of the sensor detectable area data group 35 according to the second embodiment.

A sensor detectable area 1100 indicates a sensor detectable area for the external environment sensor 4-2. It shows a detection range for the external environment sensor 4-2 that is divided into grid-like patterns on a polar coordinate system, in which a level of detection capability (detection capability level) of the external environment sensor 4-2 is evaluated for each of divided areas (cells). A grid width in a distance direction and the same in an angle direction on the polar coordinate system are set properly according to a required representation granularity.

A table 1110 shows an example of a data structure of the sensor detectable area 1100. Because the sensor detectable area 1100 is divided into grid-like patterns on the polar coordinate system, data in the table 1110 are managed as a two-dimensional array of data defined in the distance direction and the angle direction. Each element making up the array corresponds to each cell making up the sensor detectable area 1100, and has a detection capability level stored in the element. In this example, detection capability levels range from 0 to 100, and the larger the detection capability level value, the higher the detection capability of the sensor at a relative position corresponding to a cell.

In this example, the data structure of FIG. 11 is shown as an example of the sensor detectable area data, but expression of the data structure is not limited to this. For example, a cell area with a detection capability level higher than a given threshold may be defined as a sensor detectable area. Furthermore, for example, the data structure may be converted into one in which data is expressed as a combination of a detectable distance and a detectable angle range, as in the first embodiment.

### (Sensor Detectable Area Determining Process)

FIG. 12 is a flowchart for explaining a process the sensor detectable area determining unit 13 of FIG. 6 executes in the second embodiment. The second embodiment provides a method by which a detection capability at a detection position is evaluated based on whether each sensor group is able to detect integrated detection information in a detection range for the sensor group. The sensor detectable area determining unit 13 executes processes of S1201 to S1211 for each sensor group to generate sensor detectable area data on each sensor group, and stores the generated sensor detectable area data in the storage unit 30, as the sensor detectable area data group 35.

First, at S1201, sensor detectable area information SA on the sensor group S, the information being calculated in the previous process, is acquired from the sensor detectable area data group 35 stored in the storage unit 30.

Subsequently, at S1202, the latest value ObList of integrated detection information is acquired from the integrated detection information data group 34 stored in the storage unit 30.

Subsequently, at S1203, a detection capability level stored in each cell of the sensor detectable area information SA is reduced by Aa. The detection capability of a cell not updated for a long time cannot be determined. For this reason, the detection capability level of each cell is reduced to lower the detection capability level in accordance with time passage. This prevents a case of improperly overestimating the detection capability.

Subsequently, processes of S1204 to S1211 are executed on each entry included in ObList. At S1204, whether an unprocessed entry is present in ObList is determined. When an unprocessed entry is not present (N at S1204), the process flow proceeds to S1212. When an unprocessed entry is present (Y at S1204), the process flow proceeds to S1205, at which one unprocessed entry Ob is extracted.

Then, at S1206, an integrated detection position indicated in the integrated detection position of Ob is referred to, and whether the integrated detection position is included in the original detection range for the sensor group S is determined. When the integrated detection position indicated by Ob is outside the detection range for the sensor group S (N at S1206), the process flow returns to S1204. When the integrated detection is within the detection range (Y at S1206), the process flow proceeds to S1207.

At S1207, whether the sensor group S is included in the sensor source of Ob. When the sensor group S is included in the sensor source (Y at S1207), the process flow proceeds to S1208, at which the detection capability level of the cell of the sensor detectable area information SA, the cell corresponding to the integrated detection position indicated by Ob, is increased (+a1), and then the process flow returns to S1204.

When the sensor group S is not included in the sensor source (N at S1207), the process flow proceeds to S1209.

In this example, the detection capability level of the corresponding cell is increased based on a fact that the sensor group S is included in the sensor source of Ob. The updating content of the detection capability level, however, may be changed according to the level of a state of detection by the sensor group S. For example, the probability of being present 305 included in the sensor detection information is information equivalent to the reliability level of detection information from the sensor. A lower value of the probability of being present 305 means a lower level of state of detection, in which case it cannot be said that a detection capability at the position is high. In addition, when comparing the integrated detection position 403 of the integrated detection information with the detection position 303 of the sensor group S gives a fact that an error of the detection position of the sensor group S is larger, it cannot be said that a detection capability at the position is high. It is more preferable, therefore, that an increment (or a decrement) of the detection capability level be determined in according with information indicating the reliability of the sensor detection information (probability of being present 305) and recognition accuracy.

At S1209, the cause of a failure in detecting Ob despite being within the detection range for the sensor group S is estimated. This is the same process as S707 of the sensor detectable area determining process of the first embodiment shown in FIG. 7.

Where the cause is occlusion (Y at S1210), the process flow returns to S1204 without updating the sensor detectable area information SA. When the cause is not occlusion (N at S1210), the process flow proceeds to S1211, at which the detection capability level of the cell of sensor detectable area information SA that corresponds to the integrated detection position of Ob is reduced (−a2).

When the processes of S1204 to S1211 on all entries of ObList are completed (N at S1204), the process flow proceeds to S1212, at which SA is stored in the storage unit 30, as the sensor detectable area data group 35.

The above described one embodiment of the present invention offers the following effects.

Similar to the electronic control device of the first embodiment, the electronic control device disclosed in the second embodiment detects a drop in the performance of the first external environment sensor caused by a change in the external environment, and follows a change in an actual detectable area, thus being able to contribute to continuation of flexible and safe traveling control. The electronic control device of the second embodiment is similar to the electronic control device of the first embodiment also in the following respects: the in-vehicle sensor is used as the second external environment sensor, output from the sensor fusion system can be used, and the infra-sensor or the different vehicle may be used as the second external environment sensor.

In the second embodiment, a detectable area for the first external environment sensor is a grid-like map in which a given area is divided into grid-like patterns to express a detection capability level of the first external environment sensor in each unit area, and the sensor detectable area determining unit determines a detection capability level in each unit area of the grid-like map, based on a state of detection by the first external environment sensor of an environmental element detected by the second external environment sensor, the state of detection being indicated the in integrated detection information.

For example, the grid-like map is created by dividing an area into a grid-like patterns on a polar coordinate system, the area having an installation point of the first external environment sensor at the center of the area.

When a state of detection by the first external environment sensor is detection failure, the sensor detectable area determining unit reduce a detection capability level in a unit area corresponding to a position in a detectable area for the first external environment sensor, the position being indicated in the integrated detection information, to update the grid-like map.

In this manner, by using the grid-like map, which relative position is visible to what extent on the road surface can be determined. The grid-like map, therefore, can be applied also to complicated control for traveling on normal roads.

It should be noted that the embodiments described above are examples and the present invention is not limited to these embodiments. Various applications are possible and embodiments of various forms are included in the scope of the present invention.

For example, the above embodiments are described on the assumption that in the traveling control device 3, each process is executed by the same processing unit and storage unit. However, each process may be executed by a plurality of different processing units and storage units. In such a case, for example, processing software having a similar configuration is loaded onto each storage unit, and each processing unit executes its shared portion of the process.

Each process of the traveling control device 3 is carried out by a given operation program that is executed using a processor and a RAM. The process, however, may be carried out by dedicated hardware when necessary. In the above embodiments, the external environment sensor group, the vehicle sensor group, and the actuator group are described as individual devices independent of each other. These devices, however, may be used in the form of a combination of two or more devices on a necessary basis.

Control lines and information lines considered to be necessary for describing the embodiments are shown in drawings. It is not always the case that all the control lines and information lines included in an actual product to which the present invention is applied are depicted in drawings. It is safe to assume that, actually, almost the entire constituent elements are interconnected.

### REFERENCE SIGNS LIST

1 vehicle system
2 vehicle
3 traveling control device
4 external environment sensor group
5 vehicle sensor group
6 map information management device
7 actuator group
8 HMI device group
10 processing unit
11 information acquiring unit
12 sensor detection information integrating unit
13 sensor detectable area determining unit
14 traveling control mode determination unit
15 traveling control information generating unit
16 HMI information generating unit
17 Information output unit
30 storage unit
31 sensor detection information data group
32 vehicle information data group
33 traveling environment data group
34 integrated detection information data group
35 sensor detectable area data group
36 traveling control information data group
37 HMI information data group
38 system parameter data group
40 communication unit

1. An electronic control device incorporated in a vehicle, comprising:
a sensor detection information acquiring unit that acquires detection information from a first external environment sensor and detection information from a second external environment sensor, the first and second environment sensors being incorporated in the vehicle;
a sensor detection information integrating unit that specifies a correspondence relationship between an environmental element indicated in detection information from the first external environment sensor and an environmental element indicated in detection information from the second external environment sensor; and
a sensor detectable area determining unit that determines a relationship between a relative position and a detection capability at the first external environment sensor, based on a state of detection by the first external environment sensor of an environmental element detected by the second external environment sensor, and that, based on the relationship, determines a detectable area for the first external environment sensor.

2. The electronic control device according to claim 1, wherein
the second external environment sensor is incorporated in the vehicle,
the sensor detection information integrating unit generates integrated detection information indicating environmental elements which are detected by the first external environment sensor and the second external environment sensor and for which the correspondence relationship is specified, and
the sensor detectable area determining unit determines a detectable area for the first external environment sensor, based on a change in a state of detection by the first external environment sensor of an environmental element indicated by the integrated detection information.

3. The electronic control device according to claim 2, wherein the sensor detectable area determining unit determines a relationship between a relative position and a detection capability at the first external environment sensor, based on a detection position at which a state of detection by the first external environment sensor of an environmental element detected by the second external environment sensor has changed, the detection position being indicated in time series data of the integrated detection information.

4. The electronic control device according to claim 3, wherein the sensor detectable area determining unit also estimates a cause by which a state of detection by the first external environment sensor of an environmental element detected by the second external environment sensor has changed, and
based on the estimated cause, determines a relationship between a relative position and a detection capability at the first external environment sensor.

5. The electronic control device according to claim 4, wherein
a relationship between the relative position and the detection capability is expressed as a combination of a detectable distance and a detectable angle range, and
the sensor detectable area determining unit
estimates whether a cause of change in the state of detection is a cause related to a detection distance or a cause related to a detection angle,
determines a detectable distance for the first external environment sensor, based on the estimated cause related to the detection distance, and
determines a detectable angle range for the first external environment sensor, based on the estimated cause related to the detection angle.

6. The electronic control device according to claim 4, wherein the sensor detectable area determining unit
estimates whether a cause of change in the state of detection is occlusion by a different obstacle, and
does not use information indicating the estimated cause being occlusion by the different obstacle, as information for determining a relationship between a relative position and a detection capability at the first external environment sensor.

7. The electronic control device according to claim 1, wherein the sensor detectable area determining unit determines detection reliability of the first external environment sensor by comparing detection position information from the first external environment sensor about detection of the environmental element with detection position information from the second external environment sensor about detection of the environmental element, and determines a state of detection by the first external environment sensor, based on the detection reliability.

8. The electronic control device according to claim 2, further comprising a vehicle control information generating unit that generates control information on the vehicle, based on a detectable area for the first external environment sensor, the detectable area being determined by the sensor detectable area determining unit, and on the integrated detection information.

9. The electronic control device according to claim 2, wherein
a detectable area for the first external environment sensor is a grid-like map in which a given area is divided into grid-like patterns to express a detection capability level of the first external environment sensor in each unit area, and
the sensor detectable area determining unit determines a detection capability level in each unit area of the grid-like map, based on a state of detection by the first external environment sensor of an environmental element detected by the second external environment sensor, the state of detection being indicated in the integrated detection information.

10. The electronic control device according to claim 9, wherein when a state of detection by the first external environment sensor is detection failure, the sensor detectable area determining unit reduces a detection capability level in a unit area corresponding to a position in a detectable area for the first external environment sensor, the position being indicated in the integrated detection information.

11. The electronic control device according to claim 9, wherein the grid-like map is created by dividing an area into grid-like patterns on a polar coordinate system, the area having an installation point of the first external environment sensor at a center of the area.

12. An electronic control device incorporated in a vehicle, comprising:
a sensor detection information acquiring unit that acquires detection information from each of a plurality of external environment sensors with different detection ranges, the external environment sensors being incorporated in the vehicle; and
a sensor detectable area determining unit that compares detection results in an overlapping area of detection ranges of the plurality of external environment sensors to determine an effective detection range for at least one of the external environment sensors.

13. A control method by an electronic control device incorporated in a vehicle, the control method comprising:
a sensor detection information acquiring step of acquiring detection information from a first external environment sensor and detection information from a second external environment sensor, the first external environment sensor and second external environment sensor being incorporated in the vehicle;
a sensor detection information integrating step of specifying a correspondence relationship between an environmental element indicated in detection information from the first external environment sensor and an environmental element indicated in detection information from the second external environment sensor; and
a sensor detectable area determining step of determining a relationship between a relative position and a detection capability at the first external environment sensor, based on a state of detection by the first external environment sensor of an environmental element detected by the second external environment sensor, and determining a detectable area for the first external environment sensor, based on the relationship.
